(19) United States
(12) Patent Application Publication
(10) Pub. No.: US 2025/0239079 A1
(43) Pub. Date: Jul. 24, 2025

(54) WARNING METHOD AND WARNING SYSTEM

(71) Applicant: PEGATRON CORPORATION, TAIPEI CITY (TW)

(72) Inventor: Jonathan Guo, Taipei City (TW)

(73) Assignee: PEGATRON CORPORATION, TAIPEI CITY (TW)

(21) Appl. No.: 18/827,508

(22) Filed: Sep. 6, 2024

(30) Foreign Application Priority Data
Jan. 18, 2024 (TW) 113102073

(51) Int. Cl. G06V 20/52; G06T 7/50; G06T 7/73; G06V 40/10

(52) U.S. Cl. CPC G06V 20/52; G06T 7/50; G06T 7/73; G06V 40/10; G06T 2207/20084; G06T 2207/20101; G06T 2207/30196

(57) ABSTRACT

A warning method and a warning system are provided. The warning method includes: detecting a specified object in an image; extracting a plurality of key points on the specified object; converting a plurality of first pixel coordinates of the key points of an image coordinate system into a plurality of first world coordinates of a world coordinate system based on a transformation matrix; converting a plurality of second pixel coordinates of a control zone of the image of the image coordinate system into a plurality of second world coordinates of the world coordinate system based on the transformation matrix; and issuing a warning message in response to at least one of the first world coordinates falling into a range formed by the second world coordinates.

### CROSS-REFERENCE TO RELATED APPLICATION

This application claims the priority benefit of Taiwan application serial no. 113102073, filed on Jan. 18, 2024. The entirety of the above-mentioned patent application is hereby incorporated by reference herein and made a part of this specification.

### BACKGROUND

### Technology Field

The disclosure relates to a monitoring method and system, and in particular, relates to a warning method and a warning system.

### Description of Related Art

Conventionally, in an alarm system that uses a single camera to monitor a space control zone, the main task is to perform image recognition and processing on an image taken by the camera to obtain the object range of people or objects in the image and the warning range of the control zone of the image. Further, the overlapping area between the object range and the warning range is used to determine whether a person or object has entered the control zone, and an alarm is then issued.

However, in this method, since the single-camera screen is a planar projected image, the judgment of the relationship between the object range and the warning range is limited to the projection plane of the image, thus causing misjudgment of the following situations. That is, the people or objects in the image have not entered the warning range in the real three-dimensional space, but due to the camera's viewing angle, the people or objects in the image will still overlap with the warning range on the projected image plane.

### SUMMARY

The disclosure provides a warning method and a warning system capable of accurately detecting intrusion in a control zone through image recognition.

The disclosure provides a warning method applicable to use a processor to execute the following steps, and the steps include the following. A specified object in an image is detected. A plurality of key points on the specified object are extracted. A plurality of first pixel coordinates of the key points of an image coordinate system are converted into a plurality of first world coordinates of a world coordinate system based on a transformation matrix. A plurality of second pixel coordinates of a control zone of the image of the image coordinate system are converted into a plurality of second world coordinates of the world coordinate system based on the transformation matrix. In response to at least one of the first world coordinates falling into a range formed by the second world coordinates, a warning message is issued.

In an embodiment of the disclosure, the warning method further includes the following steps. A depth map of the image is obtained using a monocular depth estimation algorithm. The depth map includes a plurality of depth values of a plurality of pixels of the image. A plurality of interest points are extracted from the pixels, a plurality of depth values corresponding to the interest points are extracted from the depth map, and a plurality of camera coordinates are calculated based on pixel coordinates of the interest points of the image coordinate system, an internal parameter of an image acquisition device configured to acquire the image, and the depth values of the interest points. The transformation matrix between the image coordinate system and the world coordinate system are calculated based on the plurality of camera coordinates.

In an embodiment of the disclosure, the interest points include a first interest point, a second interest point, and a third interest point. The camera coordinates include first camera coordinates, second camera coordinates, and third camera coordinates. The first camera coordinates, the second camera coordinates, and the third camera coordinates are respectively coordinates of the first interest point, the second interest point, and the third interest point of the image coordinate system. The step of calculating the transformation matrix between the image coordinate system and the world coordinate system further includes the following steps. A first vector is obtained based on the first camera coordinates and the second camera coordinates. A second vector is obtained based on the first camera coordinates and the third camera coordinates. A normal vector is calculated based on the first vector and the second vector. The normal vector is normalized to obtain a normalized normal vector. A rotation matrix is obtained based on the normalized normal vector. The transformation matrix is obtained based on the rotation matrix and a translation matrix.

In an embodiment of the disclosure, the step of extracting the plurality of interest points from the pixels includes the following step. The interest points are selected in a world plane of the image based on user selection.

In an embodiment of the disclosure, the step of detecting the specified object in the image includes the following step. An object detection algorithm is executed to detect the specified object in the image.

In an embodiment of the disclosure, the step of extracting the plurality of key points on the specified object include the following step. A pose estimation algorithm is executed to extract the plurality of key points on the specified object.

The disclosure further provides a warning system including an image acquisition device and a processor. The image acquisition device is configured to acquire an image. The processor is coupled to the image acquisition device and is configured to: detect a specified object in the image, extract a plurality of key points on the specified object, convert a plurality of first pixel coordinates of the key points of an image coordinate system into a plurality of first world coordinates of a world coordinate system based on a transformation matrix, convert a plurality of second pixel coordinates of a control zone of the image of the image coordinate system into a plurality of second world coordinates of the world coordinate system based on the transformation matrix, and issue a warning message in response to at least one of the first world coordinates falling into a range formed by the second world coordinates.

To sum up, in the disclosure, the pixel coordinates of the image are converted into world coordinates to avoid misjudgment caused by the camera's viewing angle, intrusion detection in the control zone is thus accurately performed.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a warning system according to an embodiment of the disclosure.

FIG. 2 is a flow chart of a warning method according to an embodiment of the disclosure.

FIG. 3 is a schematic diagram of a display screen according to an embodiment of the disclosure.

FIG. 4 is a schematic view of an object detection result according to an embodiment of the disclosure.

FIG. 5A and FIG. 5B are schematic views of pose estimation results according to an embodiment of the disclosure.

FIG. 6 is a schematic view of interest points according to an embodiment of the disclosure.

FIG. 7 is a schematic diagram of an XY plane of a world coordinate system according to an embodiment of the disclosure.

FIG. 8 is a schematic diagram of the display screen according to another embodiment of the disclosure.

FIG. 9 is a schematic diagram of the XY plane of the world coordinate system according to another embodiment of the disclosure.

### DESCRIPTION OF THE EMBODIMENTS

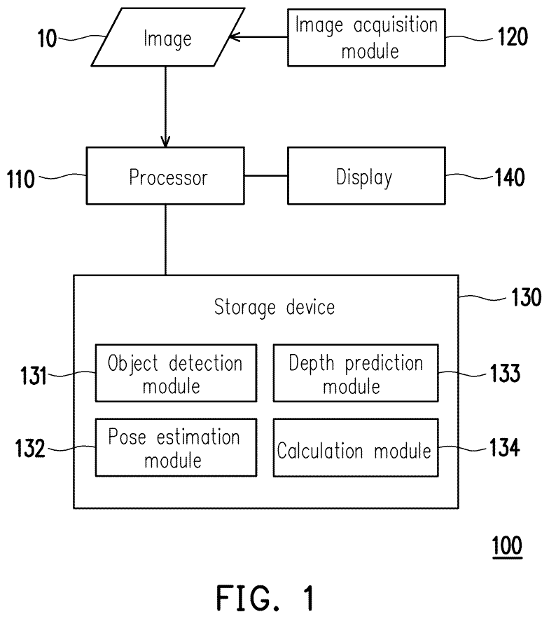

FIG. 1 is a block diagram of a warning system according to an embodiment of the disclosure. With reference to FIG. 1, a warning system 100 includes a processor 110, an image acquisition device 120, a storage device 130, and a display 140. The processor 110 is coupled to the image acquisition device 120, the storage device 130, and the display 140.

In an embodiment, the processor 110, the storage device 130, and the display 140 may be disposed in a same computer apparatus, and the image acquisition device 120 is connected to the computer apparatus in a wired or wireless manner. In another embodiment, the processor 110, the image acquisition device 120, the storage device 130, and the display 140 may also be disposed in the same computer apparatus together.

The processor 110 is, for example, a central processing unit (CPU), a physics processing unit (PPU), a programmable microprocessor, an embedded control chip, a digital signal processor (DSP), an application specific integrated circuit (ASIC), or other similar devices.

The image acquisition device 120 is, for example, a video camera or a camera using a charge coupled device (CCD) lens or a complementary metal oxide semiconductor transistor (CMOS) lens.

The memory 130 is, for example, a fixed or movable random access memory (RAM) in any form, a read-only memory (ROM), a flash memory, a hard disc or other similar devices, or a combination of the foregoing devices. The storage device 130 includes at least one code snippet, and after being installed, the code snippet is executed by the processor 110. In this embodiment, the storage device 130 includes an object detection module 131, a pose estimation module 132, a depth prediction module 133, and a calculation module 134. Each of the object detection module 131, the pose estimation module 132, the depth prediction module 133, and the calculation module 134 is formed by at least one code snippet. In other embodiments, the object detection module 131, the pose estimation module 132, the depth prediction module 133, and the calculation module 134 may also be implemented by hardware such as physical logic gates and circuits.

The display 140 is, for example, a liquid crystal display (LCD), a plasma display, and the like. In an embodiment, the display 140 may also be integrated with a touch panel to form a touch display.

In an embodiment, the image acquisition device 120 is disposed in a space to be monitored, performs photographing continuously to obtain at least one image 10, and sends the image 10 to the processor 110 for image processing in real time. After that, the processor 110 executes each module in the storage device 130 to determine whether a specified object enters the control zone based on the image 10 and decides whether to issue a warning signal. In addition, the processor 110 may further display the image 10 on the display 140.

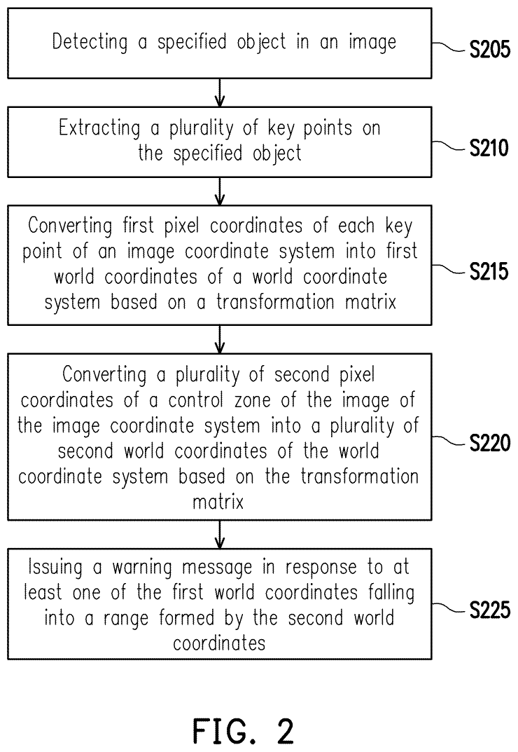

FIG. 2 is a flow chart of a warning method according to an embodiment of the disclosure. With reference to FIG. 1 and FIG. 2, in step S205, the processor 110 detects a specified object in the image 10. To be specific, the processor 110 executes an object detection algorithm through the object detection module 131 to detect the specified object in the image 10. In an embodiment, the specified object is, for example, a human body. The object detection algorithm is a neural network algorithm, such as the you only look once (YOLO) algorithm. When the specified object is detected, a bounding box is generated to select the specified object.

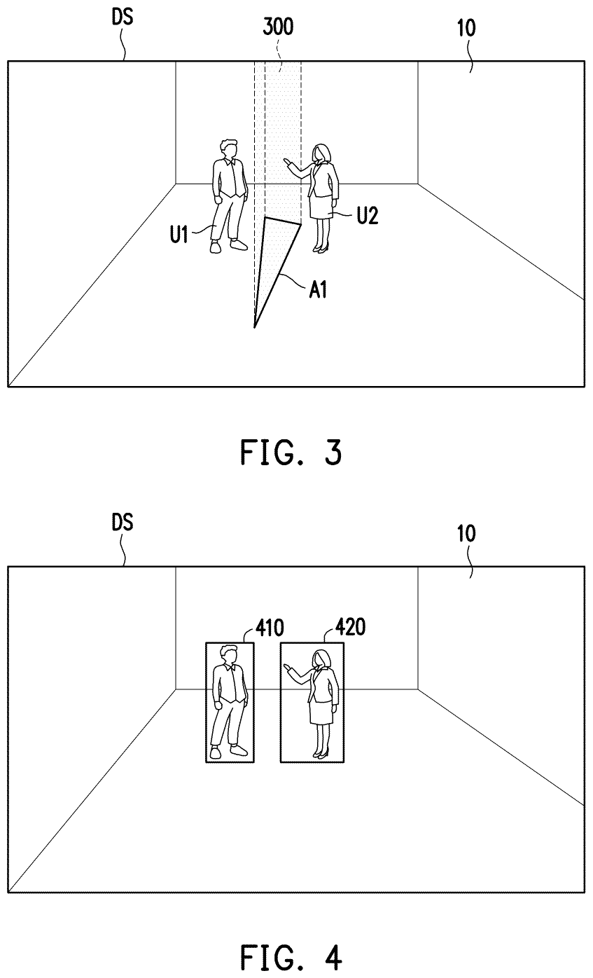

FIG. 3 is a schematic diagram of a display screen according to an embodiment of the disclosure. With reference to FIG. 3, the image 10 is displayed on a display screen DS of the display 140. As shown in FIG. 3, the image 10 includes a control zone A1 (two-dimensional). However, in a real space, the two-dimensional control zone A1 corresponds to a three-dimensional space 300. In an embodiment, the control zone A1 may be marked on the floor of the real space. Before there is any object in the real space, the image acquisition device 120 may be used to take a picture, and the picture is then sent to the processor 110 to obtain coordinate information of the control zone A1 in an image coordinate system (e.g., pixel coordinates of edge pixels of the control zone A1). In addition, in other embodiments, after the image 10 is presented on the display screen DS, the user may determine the control zone A1 of the image 10 using an input device such as a mouse or a touch panel, so that the coordinate information of the control zone A1 of the image coordinate system is accordingly obtained.

FIG. 4 is a schematic view of an object detection result according to an embodiment of the disclosure. As shown in FIG. 3, the image 10 includes two specified objects U1 and U2. The processor 110 detects the specified objects U1 and U2 in the image 10 through the object detection module 131 and obtains corresponding bounding boxes 410 and 420 respectively, as shown in FIG. 4.

Next, in step S210, the processor 110 extracts a plurality of key points on the specified objects. The processor 110 executes a pose estimation algorithm through the pose estimation module 132 to extract the key points on the specified objects. For instance, if the specified objects are human bodies, the key points are human skeleton points. A pose estimation model may adopt the PoseNet algorithm, the MoveNet algorithm, or the BlazePose algorithm.

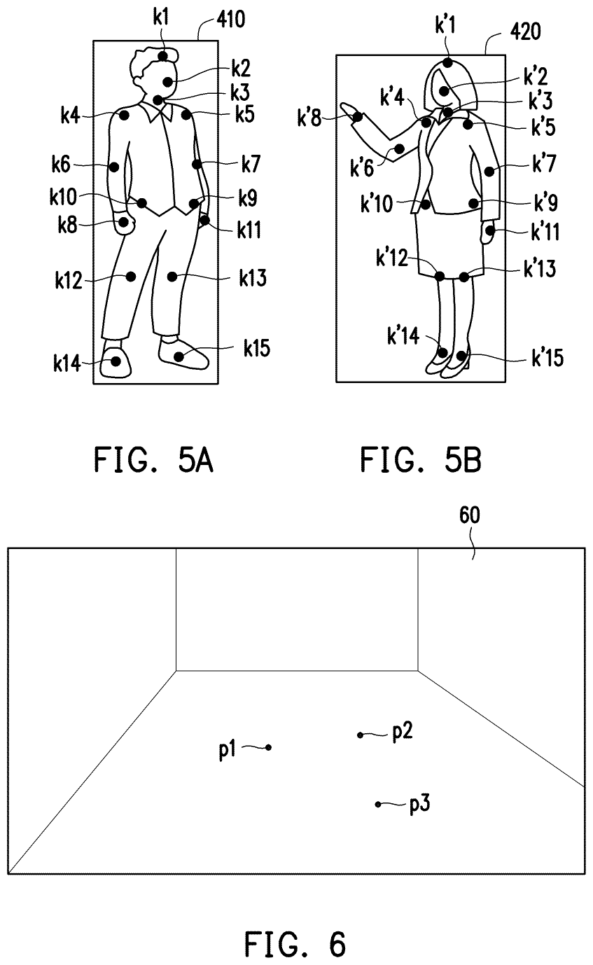

FIG. 5A and FIG. 5B are schematic views of pose estimation results according to an embodiment of the disclosure. With reference to FIG. 4, FIG. 5A, and FIG. 5B, in this embodiment, 15 human skeleton points are treated as the key points, that is, key points k1 to k15 on the specified object U1 are found in the bounding box 410, and key points k′1 to k′15 on the specified object U2 are found in the bounding box 420. In other embodiments, the number of key points may be less than 15 or more than 15, but the disclosure is not limited thereto. Next, in step S215, the processor 110 converts a plurality of first pixel coordinates of the key points of an image coordinate system into a plurality of first world coordinates of a world coordinate system based on a transformation matrix. That is, the points of the image 10 are mapped to positions in the real space. Further, in step S220, the processor 110 converts a plurality of second pixel coordinates of the control zone A1 of the image 10 of the image coordinate system into a plurality of second world coordinates of the world coordinate system based on the transformation matrix.

Herein, the processor 110 first calculates the transformation matrix between the image coordinate system and the world coordinate system to convert the pixel coordinates of the image into the world coordinates of the real space. In an embodiment, the processor 110 may execute a monocular depth estimation algorithm through the depth prediction module 133 to evaluate a depth value of each pixel of the image 10, and a corresponding depth map is then obtained. That is, the depth map includes the depth values of all pixels of the image 10. In other embodiments, before there is any object in the real space, the image acquisition device 120 may be used to acquire an image (before any object enters) and calculate a depth map of the image. After that, the processor 110 obtains the transformation matrix through the calculation

module 134. Generally, the coordinates of the world coordinate system (world coordinates) are converted into coordinates of a camera coordinate system (camera coordinates) of the image acquisition device 120 through external parameters of the image acquisition device 120. That is, the world coordinates are converted to the camera coordinates after translation and rotation. The external parameters of the image acquisition device 120 include a rotation matrix and a translation matrix. The camera coordinates of the image acquisition device 120 are then converted into pixel coordinates of a captured image (i.e., coordinates of the image coordinate system) through the projection of internal parameters. The internal parameters of the image acquisition device 120 include a focal length f and coordinates of a principal point, and the principal point is, for example, a point where a photosensitive element intersects an optical axis. Herein, a center point of the image 10 is treated as the principal point for the convenience of calculation. Accordingly, the processor 110 may use the captured image, the internal parameters and external parameters of the image acquisition device 120, and a distance estimated by depth prediction to calculate the transformation matrix for coordinate conversion between the world coordinate system and the image coordinate system.

In an embodiment, the processor 110 may select a plurality of interest points (at least three points) on a world plane (an XY plane of the world coordinate system, e.g., a real floor zone) in any image (an image with a specified object or an image without a specified object) acquired by the image acquisition device 120 to calculate the transformation matrix. For instance, the processor 110 may select the interest points of the floor zone of the image based on user selection. Alternatively, the processor 110 may determine the floor zone according to the depth map and then extract the interest points of the floor zone.

For instance, the processor 110 extracts a plurality of interest points from a plurality of pixels of any image obtained by the image acquisition device 120, extracts a plurality of depth values corresponding to the interest points from the depth map, and calculates a plurality of camera coordinates based on pixel coordinates of the interest points, an internal parameter of the image acquisition device 120, and the depth values of the interest points. After that, the processor 110 calculates the transformation matrix between the image coordinate system and the world coordinate system based on the plurality of camera coordinates.

FIG. 6 is a schematic view of interest points according to an embodiment of the disclosure FIG. 6 shows an image 60 obtained by taking a picture with the image acquisition device 120 before there is any object in the real space. The processor 110 extracts three interest points p1 to p3 from a floor zone of the image 60 to calculate the transformation matrix.

It is assumed that pixel coordinates of the interest point p1 are (u₁, v₁), pixel coordinates of the interest point p2 are (u₂, v₂), pixel coordinates of the interest point p3 are (u₃, v₃), the focal length of the image acquisition device 120 is f, and principle point coordinates are (u_{center}, v_{center}). After the interest points p1 to p3 are determined, depth values d₁, d₂, and d₃ corresponding to the interest points p1 to p3 are extracted from the depth map. Next, camera coordinates camera_1, camera_2, and camera_3 corresponding to the interest points p1 to p3 are calculated.

$$camera\_n = ( {x\_camera}_{n} , {y\_camera}_{n} , {d}_{n} ) , were n ∈ ( 1 , 2 , 3 ) ,$$

$${x\_ camera}_{n} = \frac{( {u}_{n} - {u}_{c e n t e r} ) \times {d}_{n}}{f} , and$$

$${y\_camera}_{n} = \frac{( {v}_{n} - {v}_{c e n t e r} ) \times {d}_{n}}{f} .$$

Next, a first vector vector₁ is obtained based on the camera coordinates camera_2 and the camera coordinates camera_1, and a second vector vector₂ is obtained based on the camera coordinates camera_3 and the camera coordinates camera_1. A normal vector vectorₙₒᵣₘₐₗ is obtained based on an external product of the first vector vector₁ and the second vector vector₂, and the normal vector vectorₙₒᵣₘₐₗ is normalized to obtain a normalized normal vector n_normalized. To normalize a vector is to make it unitary or to convert it to a scalar quantity. Normalization is a basic operation in vector operations. Please refer to the following formula.

$${vector}_{1} = camera\_ 2 - camera\_ 1$$

$${vector}_{2} = camera\_ 3 - camera\_ 1$$

$${vector}_{normal} = {vector}_{1} \times {vector}_{2}$$

$$n \_ normali 𝓏 ed = normali 𝓏 e ( {vector}_{n} )$$

$$normalized ( V ) = \frac{V}{\vert V \vert}$$

The following formula is then used, that is, the rotation matrix R is rotated to the Z vector (0,0,1) of the world coordinate system through the normalized normal vector n_normalized, and the 3×3 rotation matrix R is obtained:

$$R \cdot n\_ normali 𝓏 ed = ( 0 , 0 , 1 ) .$$

The rotation matrix R is then used to obtain the transformation matrix M:

$$M = [ \begin{matrix}R & T \\ {0}_{1 \times 3} & {1}_{1 \times 1}\end{matrix} ] ,$$

where T is a 3×1 translation matrix. In an embodiment, the translation matrix T is, for example, [0, 0, 0].

After the transformation matrix M is obtained, the coordinates of the key points k1 to k15 of FIG. 5A of the image coordinate system are converted into coordinates of the world coordinate system, and the coordinates of the key points k′1 to k′15 of FIG. 5B of the image coordinate system are converted into coordinates of the world coordinate system. Moreover, the coordinates of the control zone A1 of the image coordinate system are converted into coordinates of the world coordinate system, so as to determine whether the specified objects U1 and U2 enter the three-dimensional space 300 corresponding to the control zone A1.

After that, in step S225, in response to at least one of the first world coordinates falling into a range formed by the second world coordinates, the plurality of 110 issues a warning message. For instance, the processor 110 transmits the warning message to an audio output device (e.g., a speaker, a stereo, an amplifier, etc.), so that the audio output device outputs an audio signal to remind the user. Alternatively, the processor 110 transmits the warning message to the display 140, so that the display 140 displays a text message, a static image message, or a dynamic image message for reminding the user. Alternatively, the processor 110 transmits the warning message to a light-emitting device, so that the light-emitting device emits light to achieve the warning effect.

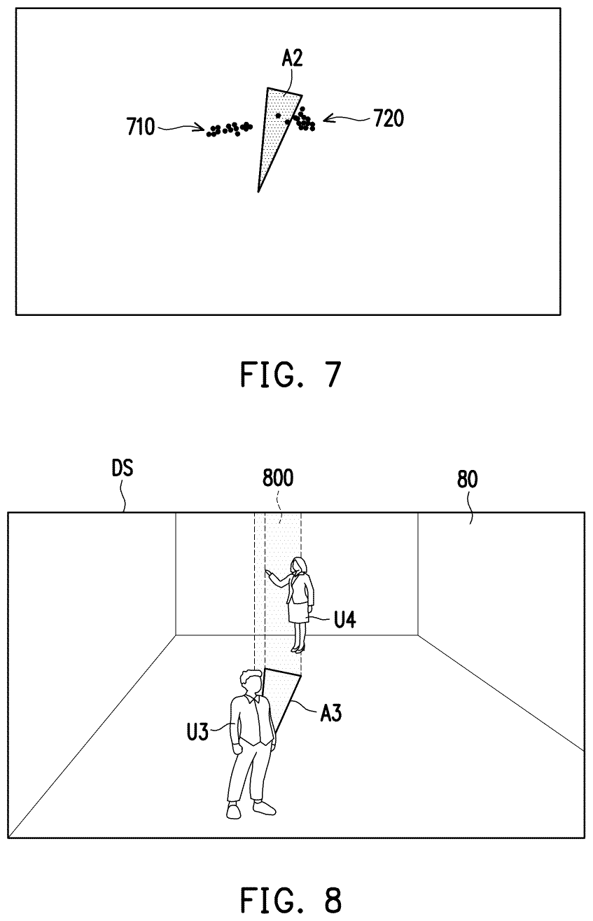

FIG. 7 is a schematic diagram of an XY plane of a world coordinate system according to an embodiment of the disclosure. With reference to FIG. 3, FIG. 5A, FIG. 5B, and FIG. 7 together, a zone A2 shown in FIG. 7 is the XY plane of the space 300 corresponding to the control zone A1 in the world coordinate system. A point set 710 includes key points k1 to k15 corresponding to the world coordinates of the world coordinate system, and a point set 720 includes key points k′1 to k′15 corresponding to the world coordinates of the world coordinate system. The processor 110 determines that some points in the point set 720 fall within the range of the zone A2 and thus determines that the specified object U2 has entered the control zone A1.

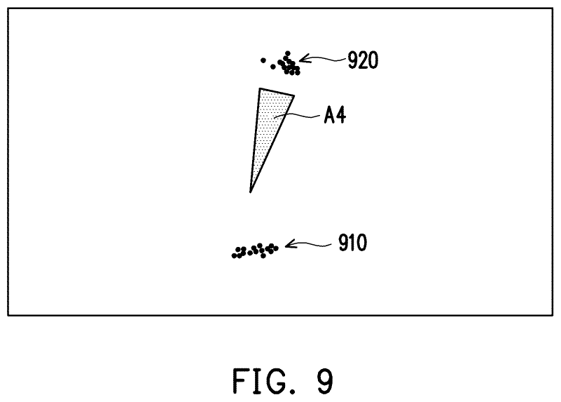

FIG. 8 is a schematic diagram of the display screen according to another embodiment of the disclosure. With reference to FIG. 8, an image 80 is displayed on the display screen DS of the display 140. As shown in FIG. 8, the image 80 includes a control zone A3 (two-dimensional). However, in a real space, the two-dimensional control zone A3 corresponds to a three-dimensional space 800. The processor 110 uses the object detection module 131 to determine that the image 80 includes two specified objects U3 and U4. The processor 110 then uses the pose estimation module 132 to obtain key points of the specified objects U3 and U4, uses the depth prediction module 133 to obtain a depth map of the image 80, uses the calculation module 134 to obtain the transformation matrix, and uses the calculation module 134 to convert pixel coordinates of the control zone A3 and pixel coordinates of the key points of the specified objects U3 and U4 into world coordinates, and then obtains the schematic diagram shown in FIG. 9.

FIG. 9 is a schematic diagram of the XY plane of the world coordinate system according to another embodiment of the disclosure. A zone A4 shown in FIG. 9 is the XY plane of the space 800 corresponding to the control zone A3 in the world coordinate system. A point set 910 includes world coordinates of the key points of the specified object U3, and a point set 920 includes world coordinates of the key points of the specified object U4. The processor 110 determines that both the point sets 910 and 920 are not within the range of the zone A4 and thus determines that the specified objects U3 and U4 have not entered the control zone A3.

In view of the foregoing, in the disclosure, a monocular depth estimation algorithm is used to obtain a depth map corresponding to an image. The control zone of the planar projected image and the key points in the specified object are then projected back to the world coordinate system based on the depth map. Intrusion detection in the control zone may be performed accurately through the use of the world coordinates.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A warning method applicable to use a processor to execute the following steps, comprising:
detecting a specified object in an image;
extracting a plurality of key points on the specified object;
converting a plurality of first pixel coordinates of the key points of an image coordinate system into a plurality of first world coordinates of a world coordinate system based on a transformation matrix;
converting a plurality of second pixel coordinates of a control zone of the image of the image coordinate system into a plurality of second world coordinates of the world coordinate system based on the transformation matrix; and
issuing a warning message in response to at least one of the first world coordinates falling into a range formed by the second world coordinates.

2. The warning method according to claim 1, further comprising:
obtaining a depth map of the image using a monocular depth estimation algorithm, wherein the depth map comprises a plurality of depth values of a plurality of pixels of the image;
extracting a plurality of interest points from the pixels, extracting a plurality of depth values corresponding to the interest points from the depth map, and calculating a plurality of camera coordinates based on pixel coordinates of the interest points of the image coordinate system, an internal parameter of an image acquisition device configured to acquire the image, and the depth values of the interest points; and
calculating the transformation matrix between the image coordinate system and the world coordinate system based on the plurality of camera coordinates.

3. The warning method according to claim 2, wherein the interest points comprise a first interest point, a second interest point, and a third interest point, the camera coordinates comprise first camera coordinates, second camera coordinates, and third camera coordinates, the first camera coordinates, the second camera coordinates, and the third camera coordinates are respectively coordinates of the first interest point, the second interest point, and the third interest point of the image coordinate system, and the step of calculating the transformation matrix between the image coordinate system and the world coordinate system further comprises:
obtaining a first vector based on the first camera coordinates and the second camera coordinates;
obtaining a second vector based on the first camera coordinates and the third camera coordinates;
calculating a normal vector based on the first vector and the second vector;
normalizing the normal vector to obtain a normalized normal vector;
obtaining a rotation matrix based on the normalized normal vector; and
obtaining the transformation matrix based on the rotation matrix and a translation matrix.

4. The warning method according to claim 2, wherein the step of extracting the plurality of interest points from the pixels comprises:
selecting the interest points in a world plane of the image based on user selection.

5. The warning method according to claim 1, wherein the step of detecting the specified object in the image comprises:
executing an object detection algorithm to detect the specified object in the image.

6. The warning method according to claim 1, wherein the step of extracting the plurality of key points on the specified object comprises:
executing a pose estimation algorithm to extract the plurality of key points on the specified object.

7. A warning system, comprising:
an image acquisition device configured to acquire an image; and
a processor coupled to the image acquisition device and configured to:
detect a specified object in the image;
extract a plurality of key points on the specified object;
convert a plurality of first pixel coordinates of the key points of an image coordinate system into a plurality of first world coordinates of a world coordinate system based on a transformation matrix;
convert a plurality of second pixel coordinates of a control zone of the image of the image coordinate system into a plurality of second world coordinates of the world coordinate system based on the transformation matrix; and
issue a warning message in response to at least one of the first world coordinates falling into a range formed by the second world coordinates.

8. The warning system according to claim 7, wherein the processor is configured to:
obtain a depth map of the image using a monocular depth estimation algorithm, wherein the depth map comprises a plurality of depth values of a plurality of pixels of the image;
extract a plurality of interest points from the pixels, extract a plurality of depth values corresponding to the interest points from the depth map, and calculate a plurality of camera coordinates based on pixel coordinates of the interest points of the image coordinate system, an internal parameter of the image acquisition device configured to acquire the image, and the depth values of the interest points; and
calculate the transformation matrix between the image coordinate system and the world coordinate system based on the plurality of camera coordinates.

9. The warning system according to claim 8, wherein the interest points comprise a first interest point, a second interest point, and a third interest point, the camera coordinates comprise first camera coordinates, second camera coordinates, and third camera coordinates, the first camera coordinates, the second camera coordinates, and the third camera coordinates are respectively coordinates of the first interest point, the second interest point, and the third interest point of the image coordinate system, and the processor is configured to:
obtain a first vector based on the first camera coordinates and the second camera coordinates;
obtain a second vector based on the first camera coordinates and the third camera coordinates;
calculate a normal vector based on the first vector and the second vector;
normalize the normal vector to obtain a normalized normal vector;
obtain a rotation matrix based on the normalized normal vector; and
obtain the transformation matrix based on the rotation matrix and a translation matrix.

10. The warning system according to claim 8, wherein the processor is configured to:
select the interest points in a world plane of the image based on user selection.

11. The warning system according to claim 7, wherein the processor is configured to:
execute an object detection algorithm to detect the specified object in the image.

12. The warning system according to claim 7, wherein the processor is configured to execute a pose estimation algorithm to extract the key points on the specified object.
